(19) United States
(12) Patent Application Publication
(10) Pub. No.: US 2006/0010046 A1
(43) Pub. Date: Jan. 12, 2006

(54) Methods and apparatuses for locating retail consumer products

(76) Inventor: Patience Van Zandt, Sunnyvale, CA (US)

Correspondence Address: Thomas Van Zandt, #299, 5255 Stevens Creek Blvd., Santa Clara, CA, 95051, US

(21) Appl. No.: 11/179,369

(22) Filed: Jul. 12, 2005

Related U.S. Application Data
(60) Provisional application No. 60/586,702, filed on Jul. 12, 2004.

(51) Int. Cl. G06Q 30/00

(52) U.S. Cl. 705/26; 705/27

(57) ABSTRACT

Methods and apparatuses for providing the location of consumer products. A designation for a particular product or class of products is received from a consumer via a digital processing system. The consumer is automatically provided with the location of the product in relation to a specific location.

### CLAIM OF PRIORITY

This application claims priority from U.S. Provisional Application No. 60/586,702, filed on Jul. 12, 2004, entitled “Methods and Apparatuses For Locating Consumer Products”.

### FIELD

Embodiments of the invention relate generally to the field of retail consumer products and more specifically to methods and apparatuses for locating such products.

### BACKGROUND

Retail consumer products including food, clothing, and household items are typically sold in large stores that may carry several categories of such items. For example large consumer retail outlets may sell clothes, consumer electronics, household furnishings as well as all manner of food products at one store. The many items offered for sale are typically separated according to various criteria and arranged in some logical order. For example, a grocery store may have all produce in one section, refrigerated items may be in another section, and canned goods in another section. Within these divisions the products may be further separated, for example the refrigerated items may be further divided with dairy products separated from meats. Department stores may have separate sections for furniture, clothing, electronics, etc., which may also be further divided (e.g., women's clothing, children's clothing, etc.). Such divisions may be extended as far as logically necessary to aid consumers in locating items.

Beyond the logical division of the items, signs may be used to direct consumers to particular items or classes of items. For example, most grocery stores have a sign above each of several aisles of items. The signs indicate which category of items are located on the shelves in that aisle. Other signs may be used even more generally, for example a sign at the entrance of a department store may say simply “Appliances Third Floor.” Additionally, directories for shopping malls are typically located at each entrance of the mall. Such directories provide a map indicating each store in the mall and a brief explanation of what each store contains. Such directories may also be color-coded to aid in locating general categories of products or stores.

Recently some bookstores have begun providing a digital processing system (DPS) with a display that enables a consumer to input the title or author of a book and receive information as to whether or not the book is currently in stock. Such systems may also indicate the section in which the book is located. For example, if a consumer types “Harry Potter,” the consumer receives information about which Harry Potter© books are in stock, and that they are located in the “Children's” section. Such systems are limited in that they do not indicate where the desired section is located in relation to the consumer, nor do they indicate where, within the indicated section, the desired book is located.

The retailer has a great interest in ensuring that consumers know where to locate items, as a consumer who cannot locate an item may decide not to purchase it or may go elsewhere. For all the retailers desire to assist consumers in locating items, many consumers often find themselves searching for particular items or for a general class of goods for some time before locating it. Such searches can be quite frustrating and often lead to lost sales and/or a loss of patronage of a particular retailer. Retailers often employ sales assistants who can provide directions to particular items, however the cost of employing such personnel is high. Moreover, sales assistants often have difficulty in determining what a consumer is looking for, and due to the immense inventories of some establishments, it may be difficult for such personnel to know where each particular item or even general categories of items are located. More frustrating for consumers than not being able to locate an item is to get erroneous directions from a sales assistant.

As retailers attempt to remain competitive through various forms of automation they tend to reduce the number of employees. For example, as grocery checkout has become more automated over the past two decades, the number of grocery store personnel per consumer has decreased proportionally. There are therefore simply less employees that a consumer can inquire of to assist in locating items. Additionally, for the majority of employees their responsibilities are not limited to directing consumers, therefore such employees are often involved in other tasks (e.g., receiving payment, stocking shelves, cleaning, etc.). It is disruptive to such employees to be continually importuned for directions to items. Moreover it is frustrating to consumers to be ignored by employees as they tend to their other responsibilities. The situation if further exacerbated by the retailer need to continually rearrange items. That is, sales are enhanced in many ways by the continual rearranging of items within a given establishment. For example, it may be beneficial to move items on sale or new items to more prominent locations (thereby displacing items previously located there) to increase consumer awareness. Achieving the most effective use of shelf space will necessitate the continual rearrangement of items. There are also a myriad of additional reasons for the rearrangement of items (e.g., the physical properties of the building including lighting, refrigeration, electronics, etc.) that must be considered and such rearrangement seems to take place quite frequently. This means that even for a relatively small store and frequent patron, it is often difficult to locate a particular item.

Current methods, by which consumers locate items, therefore, have many distinct disadvantages. As retailers continue to consolidate and offer an increasing number of items within a single establishment, it will be more and more difficult to locate such items in a timely manner using currently available methods.

### DESCRIPTION OF THE DRAWINGS

The invention may be best understood by referring to the following description and accompanying drawings that are used to illustrate embodiments of the invention. In the drawings:

FIG. 1 is a process flow diagram illustrating a process in which the location of a desired product is provided to a consumer in accordance with one embodiment of the invention;

FIG. 2 is a block diagram illustrating one embodiment of a DPS 200 that may be used to receive a designation of a product from a consumer and provide information regarding the location of the product in accordance with various embodiments of the invention; and

FIG. 3 illustrates an exemplary output information indicating the location of a designated product in accordance with one embodiment of the invention.

### DETAILED DESCRIPTION

Overview

In accordance with various alternative embodiments of the invention, an apparatus is provide for locating retail consumer products. For one embodiment of the invention a system is provided that receives an input from a consumer (user) indicating a particular product of class of products. In response the system provides information indicating the location of the product in relation to the consumer or to a known location or entity.

For example, a consumer in a grocery store may input the product “apples,” to a DPS located in a convenient location in or proximate to the grocery store. In response to this input, the system displays a map of the grocery store indicating where in the store the apples are located and a direct route from the location of the consumer to the apples. This may take the form of a highlighted route upon the map, which indicates the most direct route from the consumer to the desired product. Additional information may be provided depending on the product. For example, if the consumer is attempting to locate a particular brand of a product, the display may not only direct the consumer to the product, but also provide a description (e.g., graphic display) of the product so that the consumer may more easily identify the desired product.

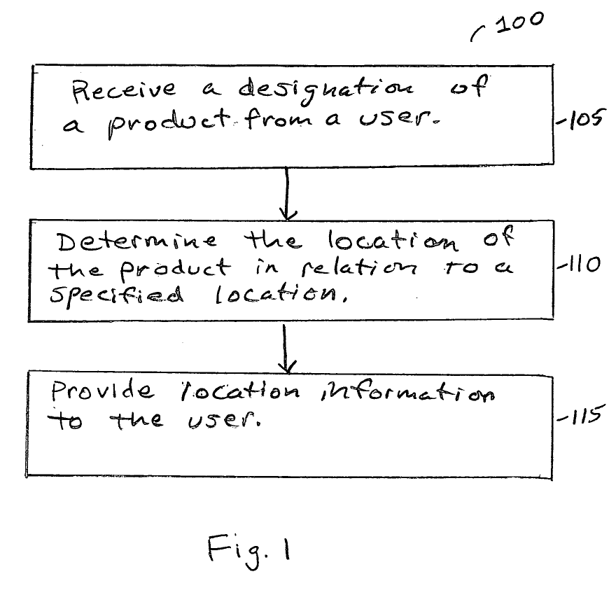

This overview represents some inventive features of various embodiments, which may contain any one of these features alone or in combination. This overview is provided to facilitate the understanding of specific embodiments of the invention discussed below in reference FIGS. 1-3. This overview does not summarize the invention, nor is it intended to be a summary.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

FIG. 1 is a process flow diagram illustrating a process in which the location of a desired product is provided to a consumer in accordance with one embodiment of the invention. Process 100, shown in FIG. 1, begins with operation 105 in which a designation of a particular product or class of products is received from a consumer. For one embodiment the consumer may type the name of the product using a keyboard of a DPS. In an alternative embodiment, the consumer may simple speak the name of the product and a voice recognition application of the DPS identifies the product. For one embodiment of the invention the consumer may be quite general in describing the product (e.g., televisions), while in alternative embodiments the consumer may be quite specific (e.g., economy-size, brand X, powdered laundry detergent). For one embodiment one or more DPSs may be located conveniently throughout a retail establishment. In an alternative embodiment, the consumer may download an application from a server DPS or central DPS to a personal DPS (e.g., a laptop computer, cell phone, or personal digital assistant (PDA)).

At operation 110 a determination is made as to the location of the product in relation to a particular location. For one embodiment the location of the product may be determined in relation to the DPS at which the product designation was received. For alternative embodiments of the invention, the location of the product may be determined in relation to a generally known or prominent location or prominent reference point (e.g., the entrance of the store or the checkout counter).

At operation 115 information regarding the determined location of the product is provided to the consumer via the DPS. The information regarding the location of the product may take many forms. For example, the information may be directions (text or spoken) that direct the consumer to the product. Additionally, or alternatively, the information may be a map of the store indicating a route from the consumer (if the consumer is at a stationery DPS) or a specific location, to the product. For one embodiment the information may provide a three-dimensional graphic representation of store shelves to indicate a precise location of a product. In an alternative embodiment of the invention where a two-dimensional representation is used, the information may include further directions such as for example “third shelf down.”

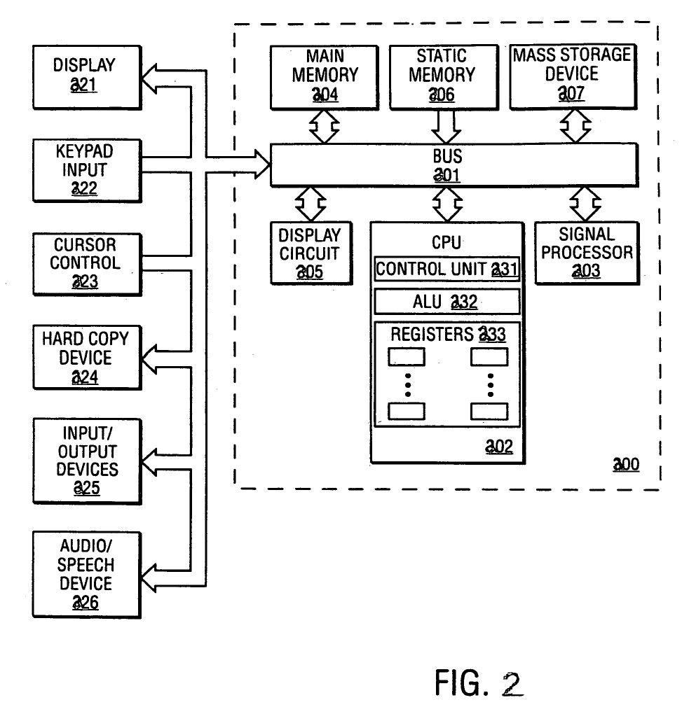

FIG. 2 is a block diagram illustrating one embodiment of a DPS 200 that may be used to receive a designation of a product from a consumer and provide information regarding the location of the product in accordance with various embodiments of the invention. For alternative embodiments of the present invention, processing system 200 may be a personal, or portable computer.

The components of processing system 200 are exemplary in which one or more components may be omitted or added. For example, one or more memory devices may be utilized for processing system 200.

Referring to FIG. 2, processing system 200 includes a central processing unit 202 and a signal processor 203 coupled to a main memory 204, static memory 206, and mass storage device 207 via bus 201. Processing system 200 may also be coupled to input/output (I/O) devices 225, and audio/speech device 226 via bus 201. Bus 201 is a standard system bus for communicating information and signals. CPU 202 and signal processor 203 are processing units for processing system 200. CPU 202 or signal processor 203 or both may be used to process information and/or signals for processing system 200. CPU 202 includes a control unit 231, an arithmetic logic unit (ALU) 232, and several registers 233, which are used to process information and signals. Signal processor 203 may also include similar components as CPU 202.

Main memory 204 may be, e.g., a random access memory (RAM) or some other dynamic storage device, for storing information or instructions (program code), which are used by CPU 202 or signal processor 203 to store and communicate product designations and location information including graphical representations of the products and locations. Main memory 204 may store temporary variables or other intermediate information during execution of instructions by CPU 202 or signal processor 203. Static memory 206, may be, e.g., a read only memory (ROM) and/or other static storage devices, for storing information or instructions, which may also be used by CPU 202 or signal processor 203. Mass storage device 207 may be, e.g., a hard or floppy disk drive or optical disk drive, for storing information or instructions for processing system 200.

A product identification and location function in accordance with the present invention can be implemented by hardware and/or software contained within computing system 200. For example, CPU 202 or signal processor 203 can execute code or instructions stored in a machine-readable medium, e.g., main memory 204. For various embodiments of the invention, the memory 206 or mass storage device 207 may be used to store valid address portions, valid addresses, or some representation of thereof. The memory 206 may be used to store the instructions to effect the association of a consumer input with a product designation and location in accordance with various embodiments of the invention.

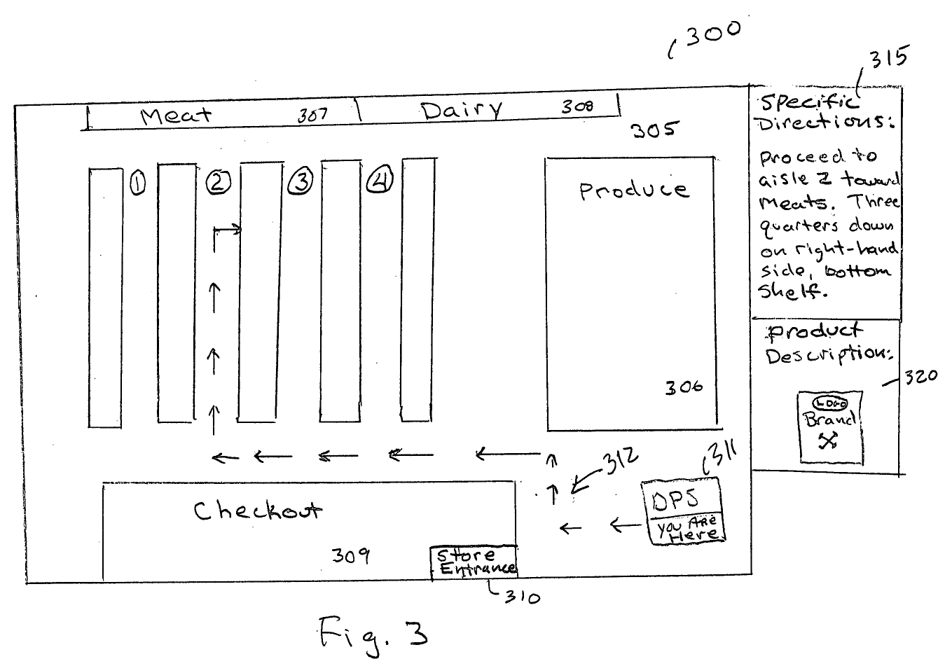

FIG. 3 illustrates an exemplary output information indicating the location of a designated product in accordance with one embodiment of the invention. Product location information 300 includes a map of a commercial establishment 305 which may designate sections of a store such as produce 306, meat 307, dairy 308, checkout 309, as well as aisles 1-4. The map 305 may also designate the store entrance 310 and the stationery DPS 311 used to receive the product designation from the consumer. The map 305 may also include directional arrows 312 that proceed from the DPS 311 to the desired product. For one embodiment of the invention, the directional arrows are highlighted, flashing, or emphasized in some way to draw the consumer's attention to the location of the product. The product location information 300 also includes a set of specific directions 315 which indicate how the consumer is to proceed to the product. For example, the set of directions may be one or more discrete directions. The product location information 300 also includes a product description 320 which may further aid the consumer in locating the desired product. The product description 320 may include a graphic image of the product or a text description. For various alternative embodiments of the invention, the specific directions and/or the product description may alternatively, or additionally, be text and/or spoken information.

General Matters

Embodiments of the invention have been described in the context of automatically providing the location of a designated product. However, alternative embodiments of the invention may allow the user to designate a class of products.

Embodiments of the invention are described as processes that include various operations that are described in their most basic form, but operations can be added to or deleted from any of these processes without departing from the basic scope of the invention. The various operations, may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A computer-implemented method comprising:
receiving an input from a user via a digital processing system, the input specifying a product;
automatically providing information to the consumer via the digital processing system, the information indicating the location of the product in relation to a specified location.

2. The computer-implemented method of claim 1 wherein the specified location is a location of the digital processing system.

3. The computer-implemented method of claim 1 wherein the information includes a map of a commercial establishment having a directional indicator that directs the user from a specified location to the product.

4. The computer-implemented method of claim 1 wherein the specified location is a location of a prominent reference point.

5. The computer-implemented method of claim 3 wherein the information further includes a set of specific directions from the specified location to the product.

6. The computer-implemented method of claim 3 wherein the information further includes a description of the product.

7. A machine-readable medium that provides executable instructions, which when executed by a processor, cause the processor to perform a method, the method comprising:
receiving an input from a user via a digital processing system, the input specifying a product;
automatically providing information to the consumer via the digital processing system, the information indicating the location of the product in relation to a specified location.

8. The machine-readable medium of claim 7 wherein the specified location is a location of the digital processing system.

9. The machine-readable medium of claim 7 wherein the information includes a map of a commercial establishment having a directional indicator that directs the user from a specified location to the product.

10. The machine-readable medium of claim 7 wherein the specified location is a location of a prominent reference point.

11. The machine-readable medium of claim 9 wherein the information further includes a set of specific directions from the specified location to the product.

12. The machine-readable medium of claim 9 wherein the information further includes a description of the product.

13. An apparatus comprising;
a digital processing system having a memory, the memory having stored thereon one or more product designations, each product designation corresponding to a product, and location information corresponding to each of the one or more product designations, the location information indicating the location of the corresponding product in relation to a specified location;
an input device for receiving a designation for a specified product from a user; and
an output device for providing a location information corresponding to the specified product to the user.

14. The apparatus of claim 13 wherein the specified location is a location of the digital processing system.

15. The apparatus of claim 13 wherein the location information includes a map of a commercial establishment having a directional indicator that directs the user from a specified location to the specified product.

16. The apparatus of claim 13 wherein the specified location is a location of a prominent reference point.

17. The apparatus of claim 15 wherein the information further includes a set of specific directions from the specified location to the specified product.

18. The apparatus of claim 15 wherein the information further includes a description of the specified product.
